(19) United States
(12) Patent Application Publication
(10) Pub. No.: US 2009/0130457 A1
(43) Pub. Date: May 21, 2009

(54) DIELECTRIC STRUCTURE

(75) Inventors: Wan-Don Kim, Gyeonggi-do (KR); Jae-Hyoung Choi, Gyeonggi-do (KR); Kyu-Ho Cho, Gyeonggi-do (KR); Jung-Hee Chung, Gyeonggi-do (KR); Jin-Yong Kim, Seoul (KR); Yong-Suk Tak, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/273,360

(22) Filed: Nov. 18, 2008

(30) Foreign Application Priority Data
Nov. 19, 2007 (KR) 2007-118115

(51) Int. Cl. B32B 17/06

(52) U.S. Cl. 428/432

(57) ABSTRACT

A dielectric structure includes a first dielectric layer, a buffer oxide layer and a second dielectric layer. The lower dielectric layer has a material having a perovskite structure including titanium and is formed on a substrate. The buffer oxide layer is formed on the first dielectric layer. The second dielectric layer has a perovskite structure including titanium and is formed on the buffer oxide layer.

### CROSS-REFERENCE TO RELATED APPLICATIONS

This U.S. non-provisional patent application claims priority under 35 U.S.C. §119 of Korean Patent Application No. 2007-118115, filed on Nov. 19, 2007, the entire contents of which are hereby incorporated by reference.

### BACKGROUND

1. Field

Example embodiments relate to a dielectric structure, a capacitor having the dielectric structure, and a method of forming the capacitor. More particularly, example embodiments relate to a dielectric structure having improved characteristics, a capacitor having the dielectric structure, and a method of forming the capacitor.

2. Description of the Related Art

Generally, a semiconductor device is required to have a large memory capacity and a high operation speed. Thus, techniques for manufacturing semiconductor devices have been developed to enhance degree of integration, response time and reliability. A capacitor included in the semiconductor device needs to have a large capacity to improve refresh characteristics thereof. However, unit cell areas have recently been decreasing as the degrees of integration of semiconductor devices have been increasing. Accordingly, the capacity of the capacitor in unit cells have been decreasing so that obtaining a high capacity needed for operation of the semiconductor device is becoming difficult.

Generally, the capacity of a capacitor is represented by the following equation.

C=εA/d

Here, C represents the capacity of the capacitor, ε represents the dielectric constant of a dielectric material between an upper electrode and a lower electrode of the capacitor, A represents the area of the electrodes, and d represents a distance between the upper electrode and the lower electrode. That is, a capacitor may have a large capacity when the dielectric material has a large dielectric constant, the electrode has a large area and the dielectric material has a small thickness. Accordingly, a capacitor has been developed to have various structures in which the area of the electrodes is large and the distance therebetween is short. Additionally, the capacitor has been developed to have a dielectric material of which the thickness is small. Meanwhile, research is being conducted on developing a material having a perovskite structure, such as barium strontium titanate (BST, (Ba,Sr)TiO₃), strontium titanate (STO, SrTiO₃), barium titanate (BTO, BaTiO₃), lead zirconium titanate (PZT, (Pb,Zr)TiO₃) and lanthanum-doped lead zirconium titanate (PLZT, Pb(La,Zr)TiO₃), which has a high dielectric constant, instead of a dielectric layer including an oxide layer, a nitride layer and an oxide layer (ONO) sequentially stacked.

However, the material having the perovskite structure has low band gap energy, and a leakage current may flow through a grain boundary of the material, which is formed during crystallization thereof. Thus, decreasing the thickness of the material has limitations. For example, when a capacitor has a critical dimension of less than about 0.4□μm, a dielectric material has a thickness of less than about 200 Å in consideration of a space for forming an upper electrode. Thus, the material having is needed to have good electrical characteristics at a thickness of less than about 200 Å. However, when the perovskite material having a thickness of less than about 200 Å serves as a dielectric layer of a capacitor, leakage currents exceeding the minimum standard may be generated. Accordingly, simply adopting the perovskite material as the dielectric layer of the capacitor has some problems.

### SUMMARY

Example embodiments provide a dielectric structure. A dielectric structure includes a first dielectric layer, a buffer oxide layer and a second dielectric layer. The lower dielectric layer has a material having a perovskite structure including titanium and is formed on a substrate. The buffer oxide layer is formed on the first dielectric layer. The second dielectric layer has a perovskite structure including titanium and is formed on the buffer oxide layer. In an example embodiment, each of the first and second dielectric layers may include barium strontium titanate (BST, (Ba,Sr)TiO₃), strontium titanate (STO, SrTiO₃), barium titanate (BTO, BaTiO₃ ), lead zirconium titanate (PZT, (Pb,Zr)TiO₃) and/or lanthanum-doped lead zirconium titanate (PLZT, Pb(La,Zr)TiO₃),etc.

In an example embodiment, the buffer oxide layer may have a thickness of less than about 10 Å. The buffer oxide layer may include a metal oxide having a band gap energy greater than about 4.0 eV. The buffer oxide layer may include zirconium oxide (ZrOₓ), aluminum oxide (AlOₓ), silicon oxide (SiOₓ) and/or hafnium oxide (HfOₓ), etc. The buffer oxide layer may be formed on the first dielectric layer discontinuously.

Example embodiments provide a capacitor. The capacitor includes a lower electrode, a dielectric structure and an upper electrode. The dielectric structure includes a first dielectric layer, a buffer oxide layer and a second dielectric layer. The lower dielectric layer has a material having a perovskite structure including titanium and is formed on a substrate. The buffer oxide layer is formed on the first dielectric layer. The second dielectric layer has a perovskite structure including titanium and is formed on the buffer oxide layer. The upper electrode is formed on the dielectric structure. In an example embodiment, each of the lower and the upper electrodes may include iridium (Ir), platinum (Pt), ruthenium (Ru), palladium (Pd), gold (Au), platinum manganese (PtMn), ruthenium iridium (Ruir), titanium (Ti), tungsten (W), tantalum (Ta), strontium ruthenium oxide (SrRuO₃; SRO), lanthanum nickel oxide (LaNiO₃; LNO), calcium ruthenium oxide (CaRuO₃; CRO), barium strontium ruthenium oxide ((Ba,Sr)RuO₃; BSR), titanium nitride (TiN), titanium aluminum nitride (TiAlNₓ), tantalum silicon nitride (TaSiNₓ), titanium silicon nitride (TiSiNₓ) and/or tantalum aluminum nitride (TaAlNₓ), etc.

In an example embodiment, each of the first and second dielectric layers may include barium strontium titanate (BST, (Ba,Sr)TiO₃), strontium titanate (STO, SrTiO₃), barium titanate (BTO, BaTiO₃), lead zirconium titanate (PZT, (Pb,Zr)TiO₃) and lanthanum-doped lead zirconium titanate (PLZT, Pb(La,Zr)TiO3), etc.

In an example embodiment, the buffer oxide layer may be formed on the first dielectric layer discontinuously. The buffer oxide layer may have a thickness of about 5 Å.

In an example embodiment, the lower electrode may have a pillar shape protruding from a substrate. The lower electrode may have a cylinder shape protruding from a substrate.

In an example embodiment, the lower electrode may be a ruthenium (Ru) electrode, each of the first and second dielectric layers may include barium strontium titanate (BST, (Ba,Sr)TiO₃) and strontium titanate (STO, SrTiO₃), the buffer oxide layer may include at least one selected from a group consisting of zirconium oxide (ZrOₓ), aluminum oxide (AlOₓ), and the upper electrode may include ruthenium (Ru) electrode and strontium ruthenium oxide (SrRuO₃; SRO) electrode.

Example embodiments provide a method of forming a capacitor. An insulating interlayer is formed on a substrate. An opening is formed through the insulating interlayer to expose a portion of the substrate. The lower electrode layer fills the opening. The insulating interlayer is removed to expose the lower electrode layer. A first dielectric layer having a perovskite structure using titanium is formed on the lower electrode. A buffer oxide layer is formed on the first dielectric layer. A second dielectric layer having a perovskite structure using titanium is formed on the buffer oxide layer. An upper electrode layer is formed on the upper dielectric layer.

In an example embodiment, the buffer oxide layer may include zirconium oxide (ZrOₓ), aluminum oxide (AlOₓ), silicon oxide (SiOₓ) and/or hafnium oxide (HfOₓ), etc.

In an example embodiment, the buffer oxide layer may have a thickness substantially the same as the lattice constant of a material therein. The buffer oxide layer may be formed on the first dielectric layer discontinuously. The buffer oxide layer may have a thickness of less than about 10 Å.

According to example embodiments, a dielectric structure has a structure in which a buffer dielectric layer pattern of metal oxide having relatively a high band gap energy is disposed between at least two dielectric layer patterns including metal compound having titanium. Accordingly, a capacitor having the dielectric structure may have an improved dielectric constant and reduced leakage current characteristics.

### BRIEF DESCRIPTION OF THE DRAWINGS

Example embodiments will be more clearly understood from the following detailed description taken in conjunction with the accompanying drawings. FIGS. 1 to 10 represent non-limiting, example embodiments as described herein.

FIG. 1 is a cross-sectional view illustrating a capacitor in accordance with example embodiments;

FIG. 2 is a cross-sectional view illustrating a capacitor in accordance with other example embodiments;

FIGS. 3A to 3E are cross-sectional views illustrating a method of manufacturing a capacitor in accordance with example embodiments;

FIGS. 4A and 4B are cross-sectional views illustrating a method of manufacturing a capacitor in accordance with other example embodiments;

FIG. 5 is a graph showing leakage currents of capacitors in accordance with Comparative Examples 1 and 2;

FIG. 6 is a graph showing leakage currents of capacitors in accordance with Examples 1 and 2;

FIG. 7 is a graph showing leakage currents of capacitors in accordance with Examples 3 and 4, and Comparative Example 3;

FIG. 8 is a cross-sectional view illustrating a capacitor in accordance with Comparative Examples 4;

FIG. 9 is a cross-sectional view illustrating a capacitor in accordance with Example 5; and

FIG. 10 is a graph showing leakage currents of capacitors in accordance with Comparative Example 4 and Example 5.

### DESCRIPTION OF EMBODIMENTS

This application claims priority under 35 U.S.C. §119 to Korean Patent Application No. 2007-118115, filed on Nov. 19, 2007 in the Korean Intellectual Property Office (KIPO), the contents of which are herein incorporated by reference in their entirety.

Example embodiments are described more fully hereinafter with reference to the accompanying drawings. The invention may, however, be embodied in many different forms and should not be construed as limited to the example embodiments set forth herein. Rather, these example embodiments are provided so that this disclosure will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of illustratively idealized example embodiments (and intermediate structures) of the invention. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

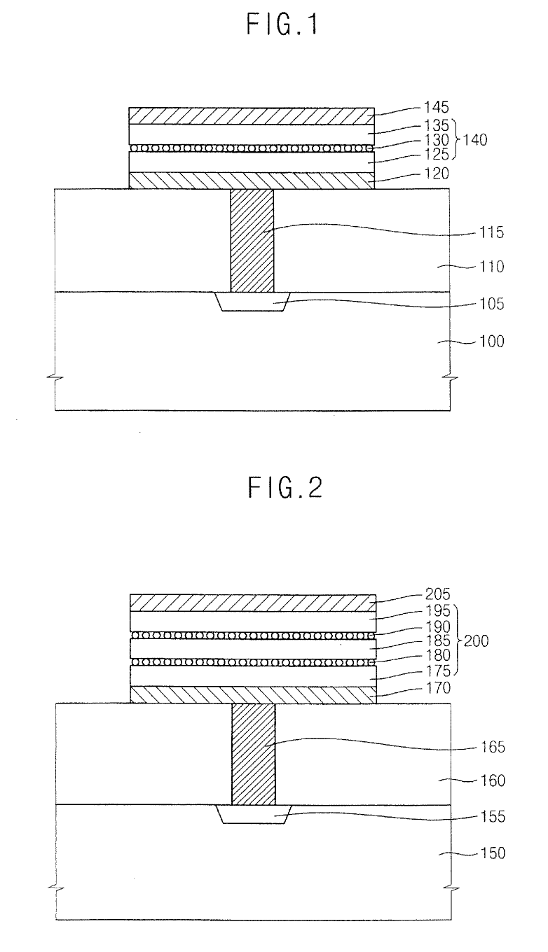

FIG. 1 is a cross-sectional view illustrating a capacitor in accordance with some example embodiments.

Referring to FIG. 1, the capacitor is provided on a substrate 100. The capacitor includes a lower electrode 120, a dielectric structure 140 and an upper electrode 145. The dielectric structure 140 may include a first dielectric layer pattern 125, a buffer dielectric layer pattern 130 and a second dielectric layer pattern 135. In some example embodiments, the capacitor may have a pillar shape or cylindrical shape.

A lower structure including a contact region 105 is formed on the substrate 100. The lower structure may further include a pad, a plug, a conductive layer pattern, an insulating layer pattern, a gate structure, a transistor, etc. The substrate 1 00 may include a semiconductor material or a metal oxide single crystalline substrate. For example, the substrate 100 may include a silicon substrate, a germanium substrate, a silicon-germanium substrate, a silicon-on-insulator (SOI) substrate, a germanium-on-insulator (GOI) substrate, an aluminum oxide substrate, a titanium oxide substrate, etc.

An insulating structure 110 is formed between the substrate 100 and the capacitor. The insulating structure 110 may include an oxide layer, a nitride layer and/or oxynitride layer. The insulating structure 110 may be formed on the substrate 100 to cover the lower structure. The oxide layer, the nitride layer and the oxynitride layer may include silicon oxide, silicon nitride and silicon oxynitride, respectively.

A pad 115 connected to the contact region 105 is formed through the insulating structure 110. The pad 115 may be formed using polysilicon, a metal and/or a metal compound. For example, the pad 115 may include polysilicon doped with impurities, titanium (Ti), tungsten (W), tantalum (Ta), aluminum (Al), copper (Cu), tungsten nitride (WNₓ), titanium nitride (TiNₓ), aluminum nitride (AlNₓ), titanium aluminum nitride (TiAlₓN_{y}), tantalum nitride (TaNₓ), tungsten suicide (WSiₓ), titanium silicide (TiSiₓ), cobalt silicide (CoSiₓ), etc. These may be used alone or in a mixture thereof.

A lower electrode 120 is formed on the pad 115 and the insulating structure 110. The lower electrode 120 may be formed using a metal, an alloy and/or a metal compound. For example, the lower electrode 120 may include iridium (Ir), platinum (Pt), ruthenium (Ru), palladium (Pd), gold (Au), platinum manganese (PtMn), ruthenium iridium (Ruir), titanium (Ti), tungsten (W), tantalum (Ta), strontium ruthenium oxide (SrRuO₃; SRO), lanthanum nickel oxide (LaNiO₃; LNO), calcium ruthenium oxide (CaRuO₃; CRO), barium strontium ruthenium oxide ((Ba,Sr)RuO₃; BSR), titanium nitride (TiN), titanium aluminum nitride (TiAlNₓ), tantalum silicon nitride (TaSiNₓ), titanium silicon nitride (TiSiNₓ), tantalum aluminum nitride (TaAlNₓ). etc. These may be used alone or in a mixture thereof.

The first dielectric layer pattern 125 of the dielectric structure 140 may include a high dielectric material including titanium. For example, the first dielectric layer pattern 125 may be formed using metal compound such as barium strontium titanate (BST, (Ba,Sr)TiO₃), strontium titanate (STO, SrTiO₃), barium titanate (BTO, BaTiO₃), lead zirconium titanate (PZT, (Pb,Zr)TiO₃) or lanthanum-doped lead zirconium titanate (PLZT, Pb(La,Zr)TiO₃). These may be used alone or in a mixture thereof. The first dielectric layer pattern 125 may have a thickness of about 30 to about 100 Å from an upper face of the lower electrode 120.

The buffer dielectric layer pattern 130 may have a thickness of less than about 10 Å and be formed on the first dielectric layer pattern 125. For example, the buffer dielectric layer pattern 130 may have a thickness of about 3 to about 5 Å. In other example embodiments, the buffer dielectric layer pattern 130 may have a thickness substantially the same as the lattice constant of a material included in the buffer dielectric layer pattern 130. In some example embodiments, the buffer dielectric layer pattern 130 may be formed on the first dielectric layer pattern 125 discontinuously. That is, the first dielectric layer pattern 125 beneath the buffer dielectric layer pattern 130 may be seen through the buffer dielectric layer pattern 130. For example, the buffer dielectric layer pattern 130 may have a plurality of island-type patterns. The buffer dielectric layer pattern 130 may improve electrical characteristics of the capacitor such as a leakage current, In some example embodiments, the buffer dielectric layer pattern 130 may include a metal oxide having a band gap energy greater than about 4.0 eV. For example, buffer dielectric layer pattern 130 may include zirconium oxide (ZrOₓ), aluminum oxide (AlOₓ), silicon oxide (SiOₓ), hafnium oxide (HfOₓ), etc. These may be used alone or in a mixture thereof. When the buffer dielectric layer pattern 130 including the metal oxide with a thickness of less than about 10 Å is formed on the first dielectric layer pattern 125, the buffer dielectric layer pattern 130 may be formed discontinuously on the first dielectric layer pattern 125.

The second dielectric layer pattern 135 is formed on the buffer dielectric layer pattern 130. The second dielectric layer pattern 135 of the dielectric structure 140 may include a high dielectric material including titanium. For example, the second dielectric layer pattern 135 may be formed using a metal compound such as barium strontium titanate (BST, (Ba,Sr)TiO₃), strontium titanate (STO, SrTiO₃), barium titanate (BTO, BaTiO₃), lead zirconium titanate (PZT, (Pb,Zr)TiO₃) or lanthanum-doped lead zirconium titanate (PLZT, Pb(La,Zr)TiO₃). These may be used alone or in a mixture thereof. The first and second dielectric layer patterns 125 and 135 may include substantially the same material or different materials. The second dielectric layer pattern 135 may have a thickess of about 30 to about 100 Å from an upper face of buffer dielectric layer pattern 130. In an example embodiment, the dielectric structure 140 may have a thickness of about 60 to about 300 Å.

An upper electrode 145 is formed on the dielectric structure 140. The upper electrode 145 may include a metal, an alloy and/or a metal compound. For example, the upper electrode 145 may include iridium (Ir), platinum (Pt), ruthenium (Ru), palladium (Pd), gold (Au), platinum manganese (PtMn), ruthenium iridium (RuIr), titanium (Ti), tungsten (W), tantalum (Ta), strontium ruthenium oxide (SrRuO₃; SRO), lanthanum nickel oxide (LaNiO₃; LNO), calcium ruthenium oxide (CaRuO₃; CRO), barium strontium ruthenium oxide ((Ba,Sr)RuO₃; BSR), titanium nitride (TiN), titanium aluminum nitride (TiAlNₓ), tantalum silicon nitride (TaSiNₓ), titanium silicon nitride (TiSiNₓ), tantalum aluminum nitride (TaAlNₓ), etc. These may be used alone or in a mixture thereof. In an example embodiment, the upper electrode 145 and the lower electrode 120 may include substantially the same material or different materials.

In the capacitor in accordance with some example embodiments, the dielectric structure 140 includes the first and second dielectric layer patterns 125 and 135 having metal compounds including titanium, and the buffer dielectric layer pattern 130 including a metal oxide having a large band gap energy, so that leakage current characteristics of the capacitor may be improved. A material layer having a perovskite structure including titanium has a different dielectric constant that changes according to an underlayer. Generally, the perovskite material layer has a large dielectric constant when the perovskite material layer is formed on a noble metal layer or a conductive perovskite oxide layer. On the other hand, the perovskite material layer has a small dielectric constant when the perovskite material layer is formed on a binary metal oxide layer. Particularly, when the perovskite material layer is formed on the binary metal oxide layer, the perovskite material layer may not have sufficiently high crystalline characteristics, or the perovskite material layer may have a small dielectric constant.

When the buffer dielectric layer pattern 130 has a large thickness, the second dielectric layer pattern 135 may not have a crystalline structure substantially the same as that of the first dielectric layer pattern 125 due to the substrate effect. Accordingly, the capacitor may have a small dielectric constant. In order to reduce the substrate effect, the buffer dielectric layer pattern 130 may have a thickness of less than about 10 Å, preferably, a thickness of about 3 to about 6 Å. In that case, the capacitor may have a large dielectric constant and a low leakage current. In other example embodiments, the buffer dielectric layer pattern 130 may have a thickness substantially the same as the lattice constant of the material included in the buffer dielectric layer pattern 130. In some example embodiments, the buffer dielectric layer pattern 130 may be a continuous single-layer. In other example embodiments, the buffer dielectric layer pattern 130 may be a discontinuous layer including a plurality of island-type patterns. As a result, the buffer dielectric layer pattern 130 may improve the electrical characteristics of the capacitor such as the leakage current characteristics.

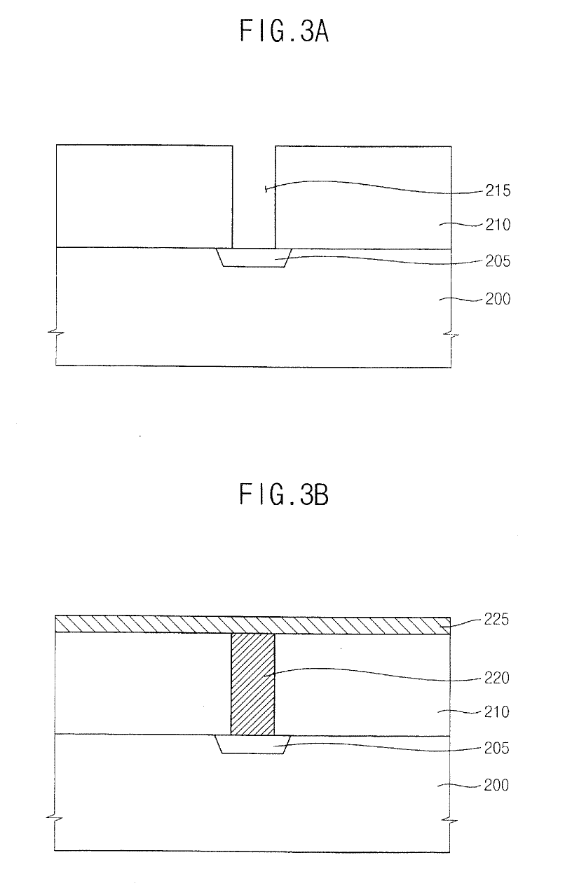

FIG. 2 is a cross-sectional view illustrating a capacitor in accordance with other example embodiments.

Referring to FIG. 2, a capacitor includes a lower electrode 1 70 on a substrate 150, a dielectric structure 200 on the lower electrode 170 and an upper electrode 205 on the dielectric structure 200. The dielectric structure 200 may include first, second and third dielectric layer patterns 175, 185 and 195 on the lower electrode 170, and first and second buffer dielectric layer patterns 180 and 190.

A lower structure including a contact region 155 is formed on the substrate 150. An insulating structure 160 is formed between the lower electrode 170 and the substrate 150. A pad 165 is formed through the insulating structure 160 to electrically connect the lower electrode 170 to the contact region 155. The pad may be formed using a doped polysilicon, metal and/or metal compound.

In an example embodiment of the present invention, a diode may be formed through the insulating structure 160 to electrically connect the lower electrode 170 to the contact region 155. The diode may include a doped polysilicon layer.

The dielectric structure 200 may include first, second and third dielectric layer patterns 175, 185 and 195 on the lower electrode 170, and first and second buffer dielectric layer patterns 180 and 190. The first, second and third dielectric layer patterns 175, 185 and 195 may include a metal compound having titanium. The first and second buffer dielectric layer patterns 180 and 190 may include a metal oxide having a band gap energy greater than about 4.0 eV. The first and second buffer dielectric layer patterns 180 and 190 may be formed discontinuously. For example, the first and second buffer dielectric layer patterns 180 and 190 may have a plurality of island-type patterns, respectively. The first buffer dielectric layer pattern 180 is formed between the first and second dielectric layer patterns 175 and 185. The second buffer dielectric layer pattern 190 is formed between the second and third dielectric layer patterns 185 and 195. The first and second buffer dielectric layer patterns 180 and 190 may have thicknesses under about 10 Å, respectively. The dielectric structure 200 may have a thickness of about 60 to 300 Å.

The upper electrode 205 is formed on the dielectric structure 200 including the plurality of dielectric layer patterns 175, 185 and 195, and the plurality of buffer dielectric layer patterns 180 and 190. The upper electrode 205 may includes a metal, an alloy and/or a conductive metal compound.

In some example embodiments, a dielectric structure including a first dielectric layer pattern to a K-th dielectric layer pattern (here, K is a positive number greater than or equal to 2) and a first buffer dielectric layer pattern to an N-th buffer dielectric layer pattern (here, N is a positive number greater than or equal to 2) may be formed on the lower electrode 170. The first buffer dielectric layer pattern to the N-th buffer dielectric layer pattern may have thickness of less than about 10 Å and be formed between the first dielectric layer pattern to the K-th dielectric layer pattern, respectively. The first dielectric layer pattern to the K-th dielectric layer pattern may include a metal compound having titanium. The first buffer dielectric layer pattern to the N-th buffer dielectric layer pattern may include a metal oxide having a band gap energy greater than about 4.0 eV.

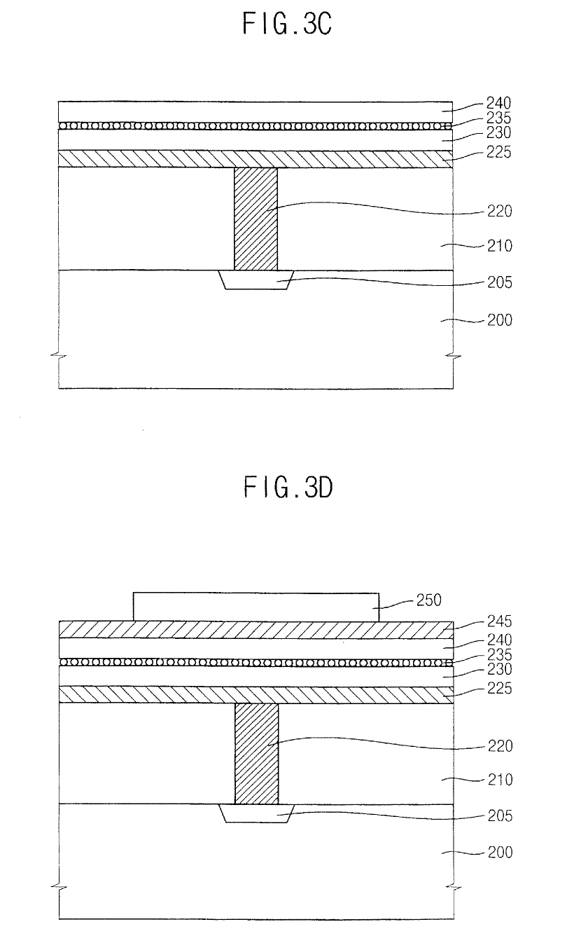

FIGS. 3A to 3E are cross-sectional views illustrating a method of forming a capacitor in accordance with some example embodiments.

Referring to FIG. 3A, a lower structure having a contact region 205 is formed on a substrate 200. The substrate 200 may include a semiconductor material or a metal oxide single crystalline substrate. For example, the substrate 200 may include a silicon substrate, a germanium substrate, a silicon-germanium substrate, a silicon-on-insulator (SOI) substrate, a germanium-on-insulator (GOI) substrate, an aluminum oxide substrate, a titanium oxide substrate, etc. The lower structure may further include a pad, a plug, a conductive layer pattern, an insulating layer pattern, a gate structure, a transistor, etc.

An insulating structure 210 is formed on the substrate 200 to cover the lower structure. The insulating structure 210 may be formed by a chemical vapor deposition (CVD) process, a low-pressure chemical vapor deposition (LPCVD) process, a plasma-enhanced chemical vapor deposition (PECVD) process, a high-density plasma chemical vapor deposition (HDP-CVD) process, etc. The insulating structure 210 may have a single-layer structure including a single oxide layer. For example, the insulating structure 210 may be formed using undoped silicate glass (USG), spin-on glass (SOG), borosilicate glass (BSG), phosphosilicate glass (PSG), borophosphosilicate glass (BPSG), flowable oxide (FOx), tetraethyl orthosilicate (TEOS), plasma-enhanced tetraethyl orthosilicate (PE-TEOS), high-density plasma chemical vapor deposition (HDP-CVD) oxide, etc. Alternatively, the insulating structure 210 may have a multilayer structure having at least one oxide layer, at least one nitride layer and/or at least one oxynitride layer. The oxide layer, the nitride layer and the oxynitride layer may be formed using silicon oxide, silicon nitride and silicon oxynitride, respectively.

An opening 215 exposing the contact region 205 is formed through the insulating structure 210 by partially etching the insulating structure 210. The opening 215 may be formed by a photolithography process.

Referring to FIG. 3B, a pad 220 filling the opening 215 is formed on the contact region 205. The pad 220 may be formed by a sputtering process, an atomic layer deposition (ALD) process, a CVD process, an electronic beam deposition process, a pulsed laser deposition (PLD) process, etc. The pad 220 may be formed using a metal, a metal compound and/or doped polysilicon. For example, the pad 220 may be formed using tungsten, titanium, aluminum, tantalum, tungsten nitride, aluminum nitride, titanium nitride, tantalum nitride, etc. These may be used alone or in a mixture thereof.

A lower electrode 225 is formed on the pad 220 and the insulating structure 210. The lower electrode 225 may be formed by an ALD process, an electric beam deposition process, a sputtering process, a CVD process, a PLD process, etc. The lower electrode 225 may be formed using a metal, an alloy and/or a metal compound. For example, the lower electrode 225 may include iridium (Ir), platinum (Pt), ruthenium (Ru), palladium (Pd), gold (Au), platinum manganese (PtMn), ruthenium iridium (Ruir), titanium (Ti), tungsten (W), tantalum (ra), strontium ruthenium oxide (SrRuO₃; SRO), lanthanum nickel oxide (LaNiO₃; LNO), calcium ruthenium oxide (CaRuO₃; CRO), barium strontium ruthenium oxide ((Ba,Sr)RuO₃; BSR), titanium nitride (TiN), titanium aluminum nitride (TiAlNₓ), tantalum silicon nitride (TaSiNₓ), titanium silicon nitride (TiSiNₓ), tantalum aluminum nitride (TaAlNₓ), etc. These may be used alone or in a mixture thereof. The lower electrode 225 is formed by depositing a conductive metal compound of a perovskite structure on the pad 220 by an ALD process, The lower electrode 225 may have a single-layer structure or multilayer structure. In an example embodiment, after forming the lower electrode 225, a heat treatment process, an ozone (O₃) treatment process, an oxygen (O₂) treatment process or a plasma heat treatment process may be additionally performed to improve electrical characteristics of the lower electrode 225.

Referring to FIG. 3C, a first dielectric layer 230 is formed on the lower electrode 225. The first dielectric layer 230 may be formed by an ALD process, an electric beam deposition process, a sputtering process, a CVD process, a PLD process, etc. The first dielectric layer 230 may be formed using a metal compound including titanium. For example, the first dielectric layer 230 may be formed using a metal compound such as barium strontium titanate (BST, (Ba,Sr)TiO₃), strontium titanate (STO, SrTiO₃), barium titanate (BTO, BaTlO₃), lead zirconium titanate (PZT, (Pb,Zr)TiO₃) and lanthanum-doped lead zirconium titanate (PLZT, Pb(La,Zr)TiO₃), etc. These may be used alone or in a mixture thereof. In an example embodiment, the first dielectric layer 230 is formed by depositing BST on the lower electrode 225 by an ALD process. The first dielectric layer 230 may have a thickness of about 30 to about 100 Å from an upper face of the lower electrode 225. In some example embodiments, after forming the first dielectric layer 230, a heat treatment process, an ozone (O₃) treatment process, an oxygen (O₂) treatment process or a plasma heat treatment process is additionally performed to improve electrical characteristics of the first dielectric layer 230.

A buffer dielectric layer 235 is formed in the first dielectric layer 230. The buffer dielectric layer 235 may be formed using a metal oxide having band gap energy greater than about 4.0 eV. For example, buffer dielectric layer 235 may include zirconium oxide (ZrOₓ), aluminum oxide (AlOₓ), silicon oxide (SiOₓ), hafnium oxide (HfOₓ), tantalum oxide (TaOₓ), lanthanum aluminum oxide (LaAlOₓ), barium zirconium oxide (BaZrOₓ), strontium zirconium oxide (SrZrOₓ), etc. These may be used alone or in a mixture thereof. The buffer dielectric layer 235 may be formed by an ALD process, an electric beam deposition process, a sputtering process, a CVD process, a PLD process, etc. In an example embodiment, the buffer dielectric layer 235 may be formed discontinuously. For example, the buffer dielectric layer pattern 130 may have a plurality of island-type patterns. The buffer dielectric layer 235 may be formed to have a thickness of less than about 10 Å from an upper face of the first dielectric layer 230. In an example embodiment, the buffer dielectric layer 235 is formed by an ALD process by depositing zirconium oxide (ZrOₓ) on the first dielectric layer 230. Accordingly, the thickness of the buffer dielectric layer 235 may be adjusted so that the buffer dielectric layer 235 is formed discontinuously or has a thin continuous layer. Because the buffer dielectric layer 235 has a very small thickness, the buffer dielectric layer 235 may be formed discontinuously.

In an example embodiment, a heat treatment process, an ozone (O₃) treatment process, an oxygen (O₂) treatment process or a plasma heat treatment process may be additionally performed to improve electrical characteristics of the buffer dielectric layer 235.

A second dielectric layer 240 is formed on the buffer dielectric layer 235. The second dielectric layer 240 may be formed using a metal compound including titanium. For example, the second dielectric layer 240 may be formed using a metal compound such as barium strontium titanate (BST, (Ba,Sr)TiO₃), strontium titanate (STO, SrTiO₃), barium titanate (BTO, BaTiO₃), lead zirconium titanate (PZT, (Pb,Zr)TiO₃) or lanthanum-doped lead zirconium titanate (PLZT, Pb(La,Zr)TiO₃). These may be used alone or in a mixture thereof. In an example embodiment, the second dielectric layer 24 may be formed by depositing BST on the buffer dielectric layer 235 by an ALD process. The second dielectric layer 240 may have a thickness of about 30 to about 100 Å from an upper face of the lower electrode 225. In an example embodiment, after forming the second dielectric layer 240, a heat treatment process, an ozone (O₃) treatment process, an oxygen (O₂) treatment process or a plasma heat treatment process is additionally performed to improve electrical characteristics of the second dielectric layer 240.

Referring to FIG. 3D, an upper electrode 245 is formed on the second dielectric layer 240. The upper electrode 245 may be formed by an ALD process, an electric beam deposition process, a sputtering process, a CVD process, a PLD process, etc. The upper electrode 245 may be formed using a metal, an alloy and/or a metal compound. For example, the upper electrode 245 may include iridium (Ir), platinum (Pt), ruthenium (Ru), palladium (Pd), gold (Au), platinum manganese (PtMn), ruthenium iridium (RuIr), titanium (Ti), tungsten (W), tantalum (Ta), strontium ruthenium oxide (SrRuO₃; SRO), lanthanum nickel oxide (LaNiO₃; LNO), calcium ruthenium oxide (CaRuO₃; CRO), barium strontium ruthenium oxide ((Ba,Sr)RuO₃; BSR), titanium nitride (TiN), titanium aluminum nitride (TiAlNₓ), tantalum silicon nitride (TaSiNₓ), titanium silicon nitride (TiSiNₓ), tantalum aluminum nitride (TaAlNₓ), etc. These may be used alone or in a mixture thereof. In an example embodiment, the upper electrode 245 is formed by depositing a conductive metal compound of a perovskite structure on the second dielectric layer 240 by an ALD process. The upper electrode 245 may have a single-layer structure or multilayer structure. In an example embodiment, after forming the upper electrode 245, a heat treatment process, an ozone (O₃) treatment process, an oxygen (O₂) treatment process or a plasma heat treatment process may be additionally performed to improve electrical characteristics of the upper electrode 245.

A mask 250 is formed on the upper electrode 245. The mask may be formed using silicon nitride, silicon oxide, silicon oxynitride, a photoresist, a metal oxide, etc. These may be used alone or in a mixture thereof. The mask 250 is formed by patterning a mask layer with a photolithography process after forming the mask 250 on the upper electrode 245.

Referring to FIG. 3E, the upper electrode layer 245, the second dielectric layer 240, the buffer dielectric layer 235, the first dielectric layer and the lower electrode layer 225 are sequentially patterned using the mask 250. Accordingly, a capacitor including a lower electrode 255, a dielectric structure 275 and an upper electrode 280 is formed on the pad 220 and the insulating structure 210. The dielectric structure includes a first dielectric layer pattern 260, a buffer dielectric layer pattern 265 and a second dielectric layer pattern 270 which are formed on the lower electrode 255. After forming the capacitor, the mask 250 is removed from the upper electrode 280.

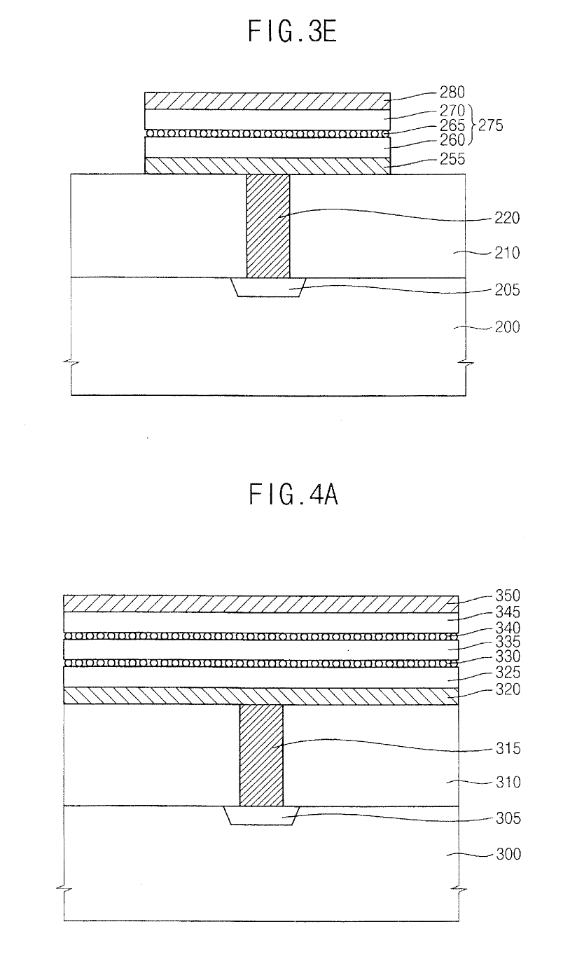

FIGS. 4A to 4B are cross-sectional views illustrating a method of manufacturing a capacitor in accordance with other example embodiments. A method of forming a lower structure having a contact region 305 on the substrate 300 and a method of forming an insulating structure 310 having a pad 315 are substantially the same as those described with reference to FIGS. 3A and 3B.

Referring FIG. 4A, a lower electrode layer 320 is formed using a metal, an alloy and/or a conductive metal compound on the insulating structure 310 and the pad 315, and then a first dielectric layer 325 is formed on the lower electrode layer 320. The first dielectric layer 325 may be formed using a metal compound including titanium.

A first buffer dielectric layer 330 having a discontinuous structure is formed on the first dielectric layer 325. A second dielectric layer 335 is formed on the first buffer dielectric layer 330. The first buffer dielectric layer 330 may be formed using a metal compound having a band gap energy greater than about 4.0 eV. The second dielectric layer 335 may be formed using a metal compound including titanium.

The second buffer dielectric layer 340 is formed on the second dielectric layer 335 with a thickness of less than about 10 Å. A third dielectric layer 345 is formed on the second buffer dielectric layer 340. The second buffer dielectric layer 340 may be formed using a metal compound having a band gap energy greater than about 4.0 eV. The third dielectric layer 345 may be formed using a metal compound including titanium. In an example embodiment, a total thickness of the first to the third dielectric layer 325, 335 and 345, and the first and the second buffer dielectric layer 340 may be adjusted to have a thickness of about 60 to about 300 Å.

An upper electrode layer 350 is formed on the third dielectric layer 345. The upper electrode layer 350 may be formed using a metal, an alloy and/or a metal compound.

In an example embodiment, a first dielectric layer to a K-th dielectric layer (here, K is a positive number greater than or equal to 2) and a first buffer dielectric layer pattern to an N-th buffer dielectric layer pattern (here, N is a positive number greater than or equal to 2) may be formed on the lower electrode 320. The first buffer dielectric layer pattern to the N-th buffer dielectric layer pattern may be formed between the first dielectric layer pattern to the K-th dielectric layer pattern, respectively.

Referring to FIG. 4B, a mask 355 is formed on the upper electrode layer 350, and then the upper electrode layer 350 to the lower electrode layer 320 are sequentially patterned to form a capacitor on the insulating structure 310 and the pad 315. The capacitor may include a lower electrode 360, a dielectric structure 390 and an upper electrode 395. The dielectric structure 390 may include first to third dielectric layer patterns 365, 370 and 385, and first and second buffer dielectric layer patterns 370 and 380, which are formed between the first to third dielectric layer pattern 365, 370 and 385, respectively. When a first dielectric layer to a K-th dielectric layer (here, K is a positive number greater than or equal to 2) and a first buffer dielectric layer pattern to an N-th buffer dielectric layer pattern (here, N is a positive number greater than or equal to 2) may be formed on the lower electrode 320, a dielectric structure may include a first to the N-th buffer dielectric layer pattern formed between the first buffer dielectric layer pattern to the N-th buffer dielectric layer pattern.

Hereafter, electrical characteristics of capacitors in accordance with some examples of the present invention and some comparative examples are described.

### EXAMPLE 1

A dielectric structure including first and second dielectric layer patterns, each of which included BST, and a buffer dielectric layer pattern including zirconium oxide was formed on a lower electrode including ruthenium. An upper electrode including ruthenium was formed on the dielectric structure. The total thickness of the first and second dielectric layer patterns was about 200 Å. The buffer dielectric layer pattern had a thickness of about 5 Å.

### EXAMPLE 2

A dielectric structure including first and second dielectric layer patterns, each of which included BST, and a buffer dielectric layer pattern including zirconium oxide was formed on a lower electrode including ruthenium. An upper electrode including ruthenium was formed on the dielectric structure. The total thickness of the first and second dielectric layer patterns was about 300 Å. The buffer dielectric layer pattern had a thickness of about 5 Å.

### EXAMPLE 3

A dielectric structure including first and second dielectric layer patterns, each of which included BST, and a buffer dielectric layer pattern including zirconium oxide was formed on a lower electrode including ruthenium. An upper electrode including ruthenium was formed on the dielectric structure. The total thickness of the first and second dielectric layer patterns was about 150 Å. The buffer dielectric layer pattern had a thickness of about 5 Å.

### EXAMPLE 4

A dielectric structure including first to third dielectric layer patterns, each of which included BST, and first and second buffer dielectric layer patterns including zirconium oxide were formed on a lower electrode including ruthenium. An upper electrode including ruthenium was formed on the dielectric structure. The total thickness of the first to third dielectric layer patterns was about 150 Å. The first and buffer dielectric layer patterns had a thickness of about 5 Å, respectively.

### COMPARATIVE EXAMPLE 1

A dielectric layer pattern including BSI is formed between an upper electrode including ruthenium and a lower electrode including ruthenium. The dielectric layer pattern had a thickness of about 200 Å.

### COMPARATIVE EXAMPLE 2

A dielectric layer pattern including BST is formed between an upper electrode including ruthenium and a lower electrode including ruthenium. The dielectric layer pattern had a thickness of about 300 Å.

### COMPARATIVE EXAMPLE 3

A dielectric layer pattern including BST is formed between an upper electrode including ruthenium and a lower electrode including ruthenium. The dielectric layer pattern had a thickness of about 150 Å.

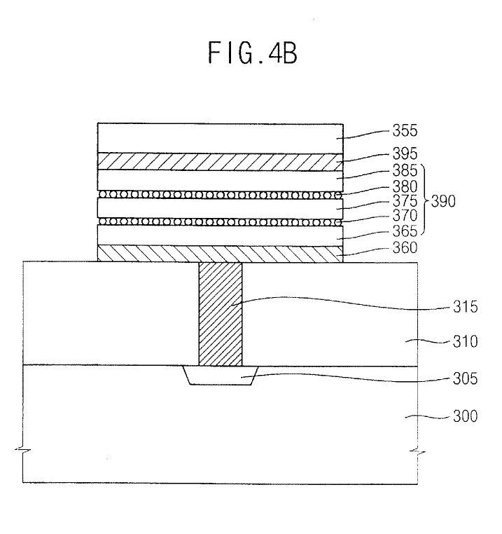

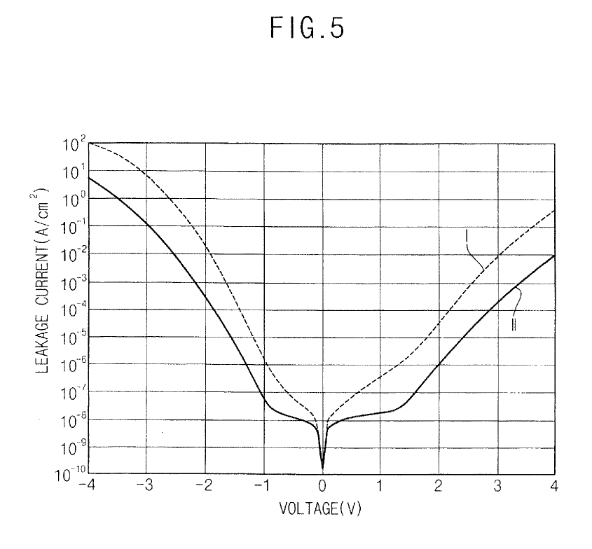

FIG. 5 is a graph showing leakage currents of the capacitors in accordance with Comparative Examples 1 and 2. FIG. 6 is a graph showing leakage currents of the capacitors in accordance with Examples 1 and 2. “I”, “II”, “III”, and “IV” in FIGS. 5 and 6 represent leakage currents of Comparative Example 1, Comparative Example 2, Example 1 and Example 2, respectively.

Referring to FIGS. 5 and 6, the capacitors in accordance with Examples 1 and 2 have leakage currents lower than those of Comparative Examples 1 and 2. Particularly, the capacitor in accordance with Example 2 has a leakage current much lower than those of Comparative Examples 1 and 2.

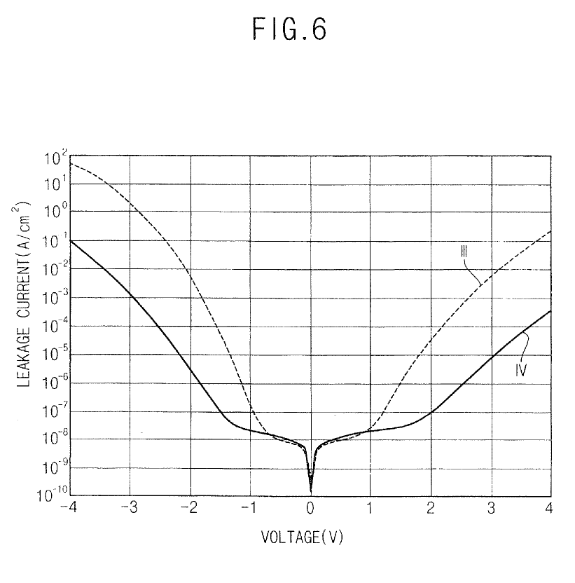

FIG. 7 is a graph showing leakage currents of the capacitors in accordance with Examples 3 and 4, and Comparative Example 3. “V”, “VI” and “VII” in FIG. 7 represent leakage currents of Example 3, Example 4 and Comparative Example 3, respectively.

As shown in FIG. 7, the capacitors (V, VI) having a structure in which a buffer dielectric layer pattern is formed between dielectric layer patterns have leakage currents better than that of a capacitor (VII) having a structure in which only a dielectric layer is formed. Particularly, when low voltage is applied to the capacitors of Examples and Comparative Examples, the capacitor having a plurality of dielectric layer patterns and buffer dielectric layer patterns has a good leakage current.

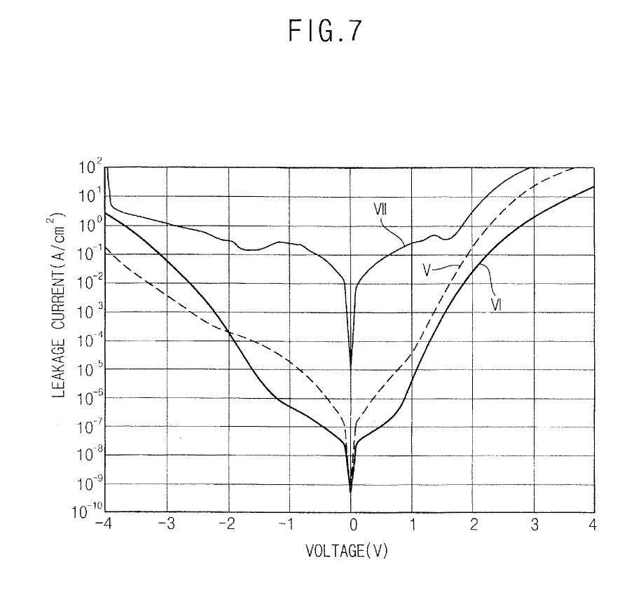

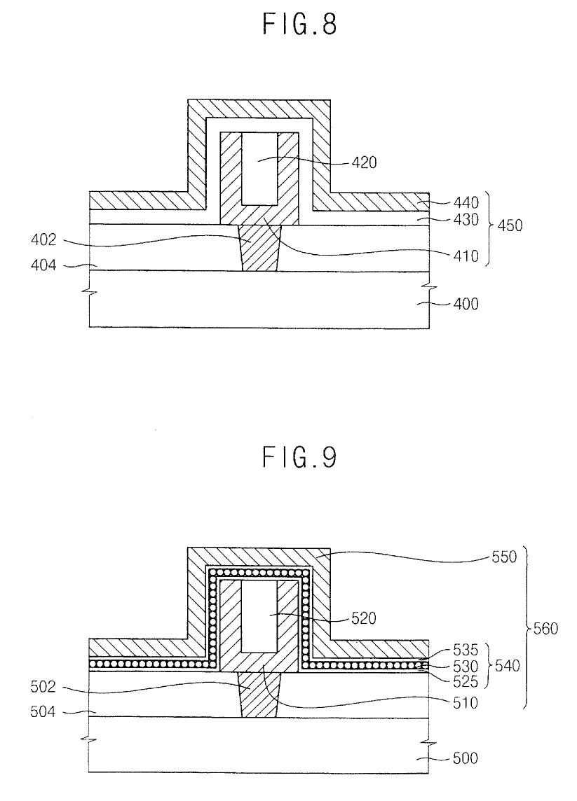

FIG. 8 is a cross-sectional view illustrating a capacitor in accordance with Comparative Example 4. FIG. 9 is a cross-sectional view illustrating a capacitor in accordance with Example 5 of the present invention.

### COMPARATIVE EXAMPLE 4

An insulating interlayer 404 was formed on a substrate 400. A plug 402 was formed through the insulating interlayer 404 on the substrate 400. An insulating layer (not shown) was formed on the insulating interlayer 404 and the plug 402. An opening (not shown) was formed through the insulating interlayer to expose a portion of the substrate 400 and the plug 402. The opening had a depth of about 8,000 Å. A first lower electrode layer pattern 410 having a cylindrical shape was formed in the opening. The first lower electrode layer pattern 410 included ruthenium, and had a height of about 8,000 Å and a thickness of about 250 Å. A space formed by the cylindrical first lower electrode was filled with a second lower electrode layer pattern 420. The second lower electrode layer pattern 420 included tantalum layer pattern 420. The first and second lower electrode layer patterns formed a lower electrode. The insulating layer was removed. A dielectric layer 430 was formed using STO to cover the lower electrode. The dielectric layer 430 had a thickness of about 130 Å. An upper electrode 440 was formed on the dielectric layer 430. The upper electrode 440 was formed using ruthenium and had a thickness of about 250 Å. As a result, a capacitor 450 including the lower electrode, the dielectric layer 430 and the upper electrode 440 was formed.

### EXAMPLE 5

An insulating interlayer 504 was formed on a substrate 500. A plug 502 was formed through the insulating interlayer 504 on the substrate 500. An insulating layer (not shown) was formed on the insulating interlayer 504 and the plug 502. An opening (not shown) was formed through the insulating interlayer to expose a portion of the substrate 500 and the plug 502. The opening had a depth of about 8,000 Å. A first lower electrode layer pattern 510 having a cylindrical shape was formed in the opening. The first lower electrode layer pattern 510 included ruthenium, and had a height of about 8,000 Å and a thickess of about 250 Å. A space formed by the cylindrical first the lower electrodes was filled with a tantalum layer pattern 520. The first and second lower electrode layer patterns formed a lower electrode. The insulating layer was removed. A dielectric layer 540 was formed to cover the lower electrode layer. The dielectric structure included a lower dielectric layer 525, a buffer dielectric layer 530 and an upper dielectric layer 535. The dielectric structure 540 had a thickness of about 130 Å. The lower dielectric layer 525 and the upper dielectric layer 535 were formed using STO. Zirconium oxide having a thickness of about 5 Å was formed between the lower dielectric layer 525 and the upper dielectric layer 535 as the buffer dielectric layer 530. An upper electrode 550 was formed on the dielectric structure 540. The upper electrode 550 was formed using ruthenium and had a thickness of about 250 Å. As a result, a capacitor 560 including the lower electrode, the dielectric structure 540 and the upper electrode 550 was formed.

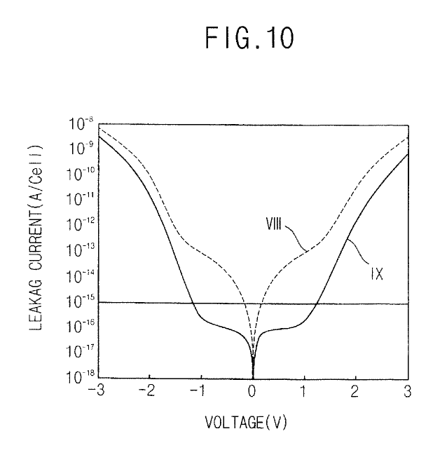

FIG. 10 is a graph showing leakage currents of capacitors in accordance with Comparative Example 4 and Example 5. “VIII” and “IX” in FIG. 10 represent leakage currents of Comparative Example 4 and Example 5, respectively.

Referring to FIG. 10, a capacitor having a structure in which a buffer layer pattern is formed on dielectric layer patterns may have improved leakage current characteristics compared to those of a capacitor having only a dielectric layer pattern. Particularly, when low voltage is applied to a capacitor, a capacitor having a structure in which a buffer layer pattern is formed between dielectric layer patterns may have good leakage current characteristics.

According to the present invention, a dielectric structure has a structure in which a buffer dielectric layer is formed between dielectric layer patterns having titanium. A capacitor having the dielectric structure has a predetermined dielectric constant and decreased a leakage current. When the capacitor is applied to a volatile or a non-volatile memory device, the memory devices may have an improved capacity and leakage current characteristics.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The invention is defined by the following claims, with equivalents of the claims to be included therein.

1. A dielectric structure comprising:
a first dielectric layer including a material having a perovskite structure on a substrate, the material including titanium;
a buffer oxide layer on the first dielectric layer; and
a second dielectric layer including a material having a perovskite structure on the buffer oxide layer, the material including titanium.

2. The dielectric structure of claim 1, wherein each of the first and second dielectric layers comprises at least one selected from the group consisting of barium strontium titanate (BST, (Ba,Sr)TiO3), strontium titanate (STO, SrTiO3), barium titanate (BTO, BaTiO3), lead zirconium titanate (PZT, (Pb,Zr)TiO3) and lanthanum-doped lead zirconium titanate (PLZT, Pb(La,Zr)TiO3.

3. The dielectric structure of claim 1, wherein the buffer oxide layer has a thickness of less than about 1.0 Å.

4. The dielectric structure of claim 1, wherein the buffer oxide layer includes a metal oxide having a band gap energy greater than about 4.0 eV.

5. The dielectric structure of claim 1, wherein the buffer oxide layer comprises at least one selected from the group consisting of zirconium oxide (ZrOx), aluminum oxide (AlOx), silicon oxide (SiOx) and hafnium oxide (HfOx).

6. The dielectric structure of claim 1, wherein the buffer oxide layer is formed on the first dielectric layer discontinuously.

7-19. (canceled)
